(19) United States
(12) Patent Application Publication
(10) Pub. No.: US 2011/0181037 A1
(43) Pub. Date: Jul. 28, 2011

(54) ALIGNMENT CLAMP

(75) Inventors: Gregory A. Griffin, Glendale Heights, IL (US); Kevin Benoit, Bradley, IL (US)

(73) Assignee: International Engine Intellectual Property Company LLC, Warrenville, IL (US)

(21) Appl. No.: 12/692,381

(22) Filed: Jan. 22, 2010

(51) Int. Cl. F16L 55/00; F16L 19/025

(52) U.S. Cl. 285/24; 285/365

(57) ABSTRACT

An alignment clamp (10) for aligning a pair of tubular members (16, 18) in a fixed, end to end relationship includes a clamp member (12) having a longitudinal axis (A), and a substantially annular interior surface (26) facing the longitudinal axis. The interior surface (26) includes a discontinuous raised surface (33) and at least one radial gap (34) between portions of the raised surface. At least one indicator key (14) is disposed on the at least one radial gap (34).

### BACKGROUND

Embodiments described herein relate to a device, system and method for accurately aligning two components at a mating joint. More specifically, embodiments described herein relate to an alignment device, system and method for aligning two components in a rotational position relative to each other.

Exhaust systems of vehicles typically include multiple components that are joined together to form a fluid passageway. The multiple components are attached to each other to have a particular rotational orientation with respect to each other so that the attached components can be located within the packaging of the vehicle. One example of exhaust system components that have a particular rotational alignment are turbocharger downpipes. When the exhaust system components have an accurate alignment, the components are located in their predetermined locations, and there is reduced stress on the exhaust system.

Often the exhaust system components are generally cylindrical in shape. Referring to FIG. 1, alignment of a mating end of a first component with a mating end of a second component in the particular alignment can be difficult to achieve when both mating ends are generally tubular-shaped.

The components are typically aligned by including a dowel pin on the first component, and including a hole for receiving the dowel pin on the second component. However, this solution can only be used when the casting is thick enough to accommodate the dowel pin and the hole. Another way that the components are aligned is by providing a non-symmetric flange on the first component and the second component, however the flanges are fixedly cast to the components, take up space, and can interfere with the packaging of other vehicle components. Further, time is spent bolting the flanges together.

### SUMMARY

An alignment clamp that aligns a pair of tubular members in a fixed, end to end relationship includes a clamp member having a longitudinal axis, and also having a substantially annular interior surface facing the longitudinal axis. The interior surface includes a discontinuous raised surface and at least one radial gap between portions of the raised surface. At least one indicator key is disposed on the at least one radial gap.

An alignment clamp system for aligning a pair of tubular members in a fixed, end to end relationship includes a clamp member having a longitudinal axis. The clamp member also has a substantially annular interior surface facing the longitudinal axis, and at least one indicator key disposed on the interior surface of the clamp member. The system includes first and second tubular members having a suitable diameter such that they can be positioned in a fixed, end to end relationship within the clamp member. The first and second tubular members each have an exterior surface having an alignment indicator. The first and second tubular members are alignable with respect to each other by aligning the alignment indicator of the first tubular member with the indicator key of the alignment clamp, and aligning the alignment indicator of the second tubular member with the indicator key of the alignment clamp.

A method of aligning a pair of tubular members in a fixed, end to end relationship includes the steps of attaching the first and second tubular members together in an end to end relationship. Both the first and the second tubular members have an alignment indicator on their respective exterior surfaces. The method also includes the step of providing an alignment clamp having a longitudinal axis, a substantially annular interior surface facing the longitudinal axis, and at least one indicator key disposed on the interior surface of the alignment clamp. The alignment clamp is engaged around the first and the second tubular members, and the first and second tubular members are rotationally aligned with respect to each other by aligning the alignment indicator of the first tubular member with the indicator key of the alignment clamp, and aligning the alignment indicator of the second tubular member with the indicator key of the alignment clamp.

### BRIEF DESCRIPTION OF THE DRAWINGS

FIG. 1 is a perspective view of a first component and a second component of an exhaust system that can be rotated with respect to each other at a mating joint.

FIG. 2 is a front perspective view of an alignment clamp.

FIG. 3 is a rear perspective view of the alignment clamp.

FIG. 4 is a series of perspective views of an alignment system, including the first component, the alignment clamp, and the alignment clamp on the first component.

### DETAILED DESCRIPTION

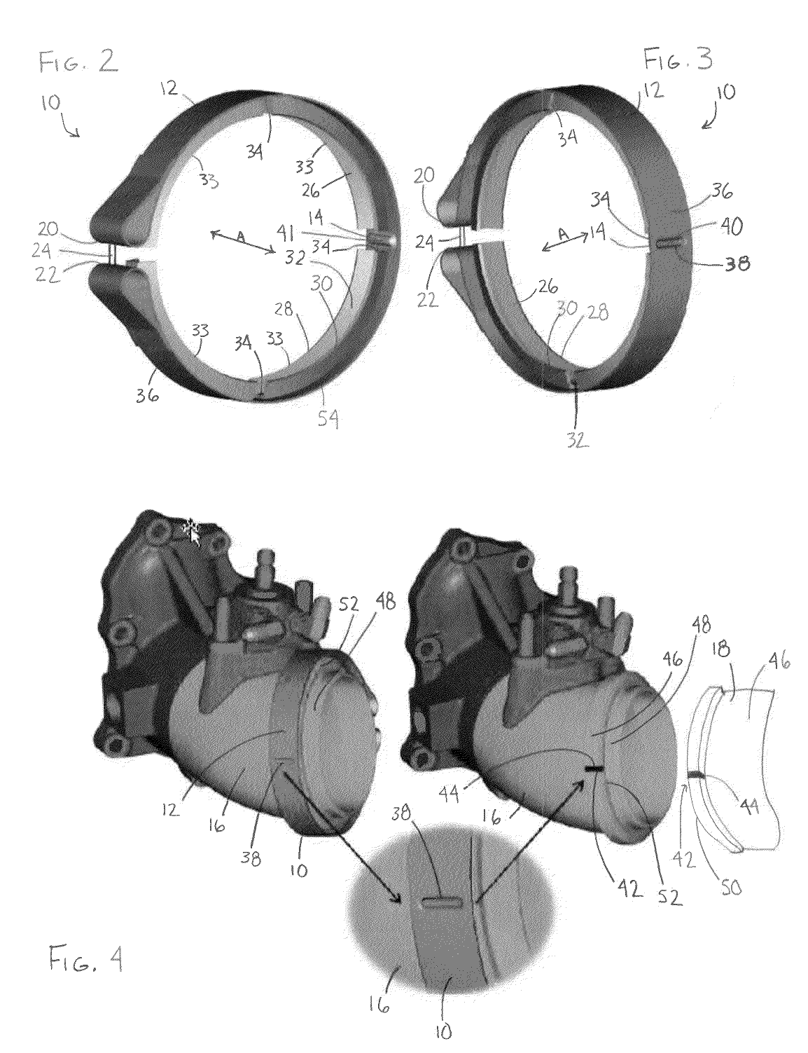

Referring to FIGS. 2 and 3, an alignment clamp is indicated at 10 and includes a clamp member 12, such as a V-band clamp. V-band clamp members 12 are conventionally known for clamping two tubular members together, however conventional V-band clamps do not clamp the tubular components together in a particular rotational position. The alignment clamp 10 includes the clamp member 12 having at least one alignment key 14 disposed on the alignment clamp.

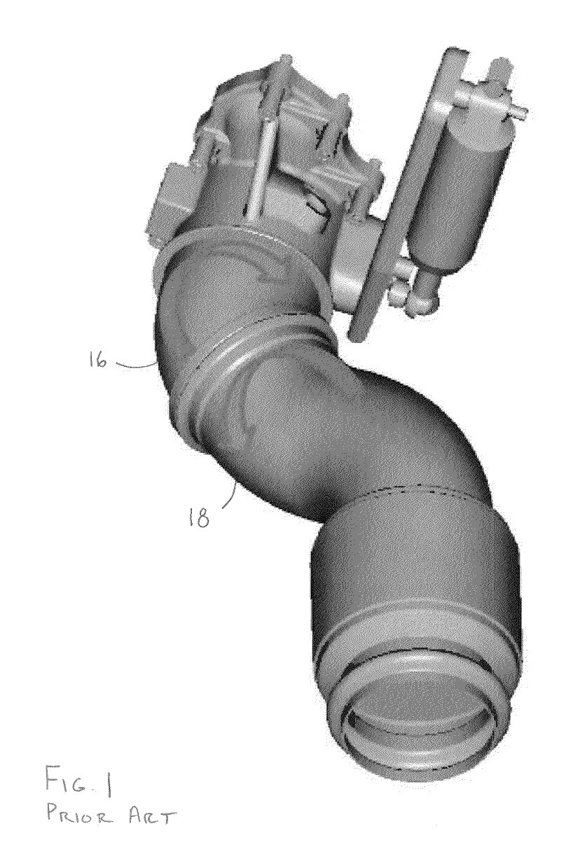

The alignment clamp 10 used to clamp and align a first tubular member 16 with a second tubular member 18 (see FIGS. 1 and 4), which may be a pair of pipes or any other tubular members. The term “tubular member” is broadly defined as any member of which at least a portion is hollow and substantially cylindrical that is suitable for conducting a fluid therethrough. The term “annular” is defined as being the shape of a closed and planar curve, which is understood as not being limited to a circle. In one application, the alignment clamp 10 is used to clamp and align the first tubular member 16 of an exhaust system to a second tubular member 18 of the exhaust system, such as two portions of a turbocharger downpipe, for the conveyance of exhaust gases through the tubular members.

As shown in FIGS. 2 and 3, latch ends 20, 22 of the alignment clamp 10 are loop-shaped and may receive a latch 24 for fixing the latch ends in a spaced, opposing relationship. Alignment clamp 10 also includes an interior surface 26 facing a longitudinal axis A of the clamp member 12.

The first and second tubular members 16, 18 have a suitable diameter such that they can be positioned in a fixed, end to end relationship, and the first and second tubular members can be longitudinally positioned within the clamp member 12. The interior surface 26 of the clamp member 12 is in clamped engagement with the exterior surface 46 of the tubular members 16, 18 adjacent to the ends of the tubular members when the latch 24 engages and closes the latch ends 20, 22 in the latched position.

The interior surface 26 may include a first substantially annular lip 28 and a second substantially annular lip 30. A recessed inner surface 32 may be disposed between the first lip 28 and the second lip 30, such that the lip 28, the recessed surface 32 and the lip 30 generally form a raised surface 33 having a general “V”-shape or a general “U”-shape, although other shapes are possible. The lips 28, may be discontinuous or segmented along the interior surface 26, leaving at least one radial gap 34 along the interior surface 26 and between portions of the raised surface 33. In the alignment clamp 10, there are three radial gaps 34 along the clamp member 12, however other numbers are possible.

The at least one alignment key 14 is located on the interior surface 26 of the alignment clamp 10 between the latch ends 20, 22. On an exterior surface 36 of the alignment clamp 10, and at the same radial position as the alignment key 14, may be an alignment key location indicator 38, such as a notch 40 or any other visual indicator. The alignment key location indicator 38 indicates on the exterior surface 36 where the alignment key 14 is located on the interior surface 26.

The alignment clamp 10 has at least one alignment key 14 on the interior surface 26. The alignment clamp 10 may have three alignment keys 14 disposed at about 90-degree radial increments and disposed in the radial gaps 34 around about the interior surface 26 of the alignment clamp, however other numbers of alignment keys and other radial increments are possible.

The alignment key 14 may be protruded or a male-shaped member, such as a tab 41, or may be recessed or a female-shaped member. Further, the alignment key may be a visual indicator, such as a painted line or indentation. It is possible that the alignment key 14 may have a stamped, welded, brazed or integrally formed construction, or any other construction that indicates the particular location on the interior surface 26 as a key for alignment of components 16, 18. In the embodiment where the alignment key 14 is the tab 41, the tab may protrude from the interior surface 26 at the radial gaps 34.

The first tubular member 16 includes at least one tubular alignment indicator 42, such as a slot 44 or any other visual indicator, on an exterior surface 46 of the tubular member 16. The tubular alignment indicator 42 may be recessed or female-shaped, or may be protruded or male-shaped. It is possible that the tubular alignment indicator 42 may have a stamped, welded, brazed or integrally formed construction, or any other construction.

In an embodiment where the alignment key 14 is male-shaped (such as tab 41), the indicator 42 may be female-shaped (such as slot 44), and in an embodiment where the alignment key is female-shaped, the indicator may be male-shaped, such that the alignment key 14 mechanically engages with the tubular alignment indicator. Alternatively, the alignment key 14 and the tubular alignment indicator 42 may not mechanically engage, but instead, the alignment key can be visually aligned with the tubular alignment indicator.

Referring now to FIG. 4, the alignment clamp 10 is engaged around the exterior surface 46 of the first tubular member 16, and the alignment key 14 is either mechanically engaged with or visually aligned with the tubular alignment indicator 42 on the first tubular member 16. The first tubular member 16 has an annular receiving surface 48 that receives the second member 18, such that a mating end 50 of the second member engages an abutting surface 52 of the first tubular member. The alignment clamp 10 may extend substantially concentrically with the annular receiving surface 48.

When the second tubular member 18 is attached to the first tubular member 16, the second tubular member is positioned between the annular receiving surface 48 and the interior surface 26 of the alignment clamp 10, and abuts the abutting surface 52. The rotational position of the second tubular member 18 can be rotationally aligned relative to the first tubular member 16 by aligning the tubular alignment indicator 42 on the second tubular member 18 with the alignment key 14 on the alignment clamp 10.

In one embodiment, if the tubular alignment indicators 42 on the first tubular member 16 and the second tubular member 18 are both slots 44, both slots can be aligned with the same tab 41 of the alignment key 14, such that one alignment clamp 10 can align and clamp both the first tubular member 16 and the second tubular member 18. In this embodiment, the tab 41 engages in both the slot 44 on the first tubular member 16 and the slot 44 in the second tubular member 18. In another embodiment, the tubular alignment indicators 42 may be visual markings that are aligned with the indicator key 14.

While FIG. 4 shows one indicator key 14, it is possible that multiple keys are disposed around the interior surface 26 of the alignment clamp 10. Further, it is possible that the indicator key 14 extends from a side surface 54 of the alignment clamp, or from both a side surface and an interior surface 26 of the alignment clamp 10. Additionally, it is possible that indicator key 14 is a pair of keys, such as a pair of tabs 41, where one tab engages a slot 44 on a first tubular member 16, and the second tab engages a slot 44 on the second tubular member 18.

The alignment clamp 10 may be formed of a cast metal such as a steel or ductile iron alloy, among other metals. Lighter alternatives such as aluminum alloys could also be employed to cast the alignment clamp 10. It is also possible that other materials can be used to form the alignment clamp.

The integrated alignment key 14 allows accurate rotational alignment of mating first and second tubular members 16, 18 in an end-to-end relationship so that the exhaust system assembly as a whole can have accurate alignment. When the assembly is accurately aligned, the components are more likely to function properly and there is reduced stress on the assembly.

What is claimed is:

1) An alignment clamp for aligning a pair of tubular members in a fixed, end to end relationship, comprising:
a clamp member having a longitudinal axis;
a substantially annular interior surface facing the longitudinal axis, wherein the interior surface includes a discontinuous raised surface and at least one radial gap between portions of the raised surface; and
at least one indicator key disposed on the at least one radial gap.

2) The alignment clamp of claim 1 wherein the clamp member has first and second latch ends that generally oppose each other.

3) The alignment clamp of claim 2 further comprising a latch that engages the first and second latch ends.

4) The alignment clamp of claim 1 wherein the raised surface is formed by a first substantially annular lip, a second substantially annular lip, and a recessed surface therebetween forming a general “V”-shape or a general “U”-shape.

5) The alignment clamp of claim 1 wherein the indicator key comprises one of a female-shaped member, a male-shaped member, and a visual marking on the radial gap.

6) The alignment clamp of claim 1 wherein the indicator key is a tab that protrudes from the interior surface of the clamp member at the radial gap.

7) The alignment clamp of claim 1 further comprising an alignment key location indicator disposed on an exterior surface of the alignment clamp at the same radial position as the at least one alignment key to indicate on the exterior surface where the at least one alignment key is located on the interior surface of the alignment clamp.

8) The alignment clamp of claim 7 wherein the alignment key location indicator is a notch on the exterior surface of the alignment clamp.

9) The alignment clamp of claim 1 wherein the alignment key has one of a stamped, welded, brazed or integrally formed construction.

10) An alignment clamp system for aligning a pair of tubular members in a fixed, end to end relationship, the system comprising:
a clamp member having a longitudinal axis, a substantially annular interior surface facing the longitudinal axis, and at least one indicator key disposed on the interior surface of the clamp member;
first and second tubular members having a suitable diameter such that they can be positioned in a fixed, end to end relationship within the clamp member, the first and second tubular members each having an exterior surface having an alignment indicator;
wherein the first and second tubular members are alignable with respect to each other by aligning the alignment indicator of the first tubular member with the at least one indicator key of the alignment clamp, and aligning the alignment indicator of the second tubular member with the at least one indicator key of the alignment clamp.

11) The system of claim 10 wherein the substantially annular interior surface includes a discontinuous raised surface and at least one radial gap between portions of the raised surface.

12) The system of claim 11 wherein the at least one alignment key is disposed on the at least one radial gap.

13) The system of claim 10 further comprising an alignment key location indicator disposed on an exterior surface of the alignment clamp at the same radial position as the at least one alignment key to indicate on the exterior surface where the at least one alignment key is located on the interior surface of the alignment clamp.

14) The system of claim 10 wherein the at least one indicator key comprises one of a female-shaped member, a male-shaped member, and a visual marking on the interior surface.

15) The system of claim 11 wherein the indicator key is a tab that protrudes from the interior surface at the radial gap.

16) The system of claim 10 wherein the alignment indicator comprises one of a female-shaped member, a male-shaped member, and a visual marking on the interior surface.

17) The system of claim 10 wherein the alignment indicator comprises a slot, and the indicator key comprises a tab, wherein the tab of the alignment clamp is received in the slot of the first tubular member and the slot of the second tubular member.

18) A method of aligning a pair of tubular members in a fixed, end to end relationship, the method comprising:
attaching the first and second tubular members together in an end to end relationship, wherein both the first and the second tubular members have at least one alignment indicator on their respective exterior surfaces;
providing an alignment clamp having a longitudinal axis, a substantially annular interior surface facing the longitudinal axis, and at least one indicator key disposed on the interior surface of the alignment clamp;
engaging the alignment clamp around the first and the second tubular members; and
aligning the first and second tubular members rotationally with respect to each other by aligning the at least one alignment indicator of the first tubular member with the at least one indicator key of the alignment clamp, and aligning the alignment indicator of the second tubular member with the indicator key of the alignment clamp.

19) The method of claim 18 wherein the at least one indicator key comprises a tab and the at least one alignment indicator comprises a slot, wherein the method further comprises the step of engaging the tab of the alignment clamp into the slot of the first and second tubular members.

20) The method of claim 18 wherein the alignment clamp comprises an alignment key location indicator disposed on an exterior surface of the alignment clamp at the same radial position as the at least one alignment key to indicate on the exterior surface where the at least one alignment key is located on the interior surface of the alignment clamp, the method further comprising the step of aligning the first tubular member with the alignment key location indicator, and aligning the alignment indicator of the second tubular member with the alignment key location indicator of the alignment clamp.
